(19) United States
(12) Patent Application Publication
(10) Pub. No.: US 2008/0264662 A1
(43) Pub. Date: Oct. 30, 2008

(54) Right-handed and reverse air channel button for a pneumatic tool

(75) Inventor: Jui-Sheng Chang, Wurih Township (TW)

Correspondence Address: SINORICA, LLC, 528 FALLSGROVE DRIVE, ROCKVILLE, MD, 20850, US

(73) Assignee: Mighty Seven International Co., Ltd.

(21) Appl. No.: 11/790,300

(22) Filed: Apr. 24, 2007

(51) Int. Cl. B23Q 5/00

(52) U.S. Cl. 173/177

(57) ABSTRACT

A right-handed and reverse air channel button for a pneumatic tool includes a basic body, at least one operating member and two air intake passageways. The basic body is pivotally positioned in a positioning hole of the base of a pneumatic tool, the operating member is secured at one side of the basic body and the air intake passageways are bored in the annular wall of the basic body. When the operating member is turned to actuate the basic body to rotate for a preset angle, the air intake a passageways will respectively correspond to an air intake channel and two guide channels of the base, which communicate with the positioning hole. Thus, air can pass through the basic body and get into the base to drive the pneumatic tool to rotate clockwise or counterclockwise, able to control the air amount, easy in assembly and convenient in operation.

### BACKGROUND OF THE INVENTION

1. Field of the Invention

This invention relates to a right-handed and reverse air channel button for a pneumatic tool, particularly to one formed integral in the interior with two air intake passageways preset in shape, simple in structure, convenient in operation and able to control the direction and amount of air getting into the base of a pneumatic tool through the right-handed and reverse air channel button.

2. Description of the Prior Art

A common pneumatic tool shown in FIGS. 1 and 2 has its base 10 bored with a positioning hole 11 communicating with an air intake channel 12, a right-handed exhaust channel 13, a reverse exhaust channel 14, a right-handed guide channel 15 and a reverse guide channel 16 of the base 10. A conventional right-handed and reverse air channel button 20 is composed of a sleeve 21 fitted in the positioning hole 11, a speed-regulating rod 22 able to be shifted axially in the sleeve 21 and two rotary buttons 23.

The sleeve 21 has its annular wall bored with an air intake hole 211 communicating with the air intake channel 12 of the base 10, a reverse exhaust hole 212 corresponding to the reverse exhaust channel 14, a right-handed exhaust hole 213 corresponding to the right-handed exhaust channel 13, a right-handed through hole 214 matching with the right-handed guide channel 15, and a reverse through hole 215 matching with the reverse guide channel 16 of the base 10.

The speed-regulating rod 22 has its front annular wall disposed with two annular recesses 221 and its central portion fixed with a bulging annular blocking member 222 having its opposite sides respectively formed with a reverse guide recess 223 and a right-handed guide recess 224. The right-handed guide recess 224 has its inner wall, axially cut with an air-controlling surface 225 so that, when the speed-regulating rod 22 is turned to have its reverse guide recess 223 corresponding to the air intake hole 211 and the reverse through hole 215 of the sleeve 21, air getting in through the air intake channel 12 of the base 10 will pass through the air intake hole 211, the reverse guide recess 223, the reverse through hole 215 and the reverse guide channel 16 and get into the pneumatic tool to drive the pneumatic tool to rotate counterclockwise. Afterward, the air producing backpressure will be exhausted out through the right-handed guide channel 15 and the right-handed through hole 214 and then through the right-handed guide recess 224, the reverse exhaust hole 212 and reverse exhaust channel 14.

On the contrary, to drive the pneumatic tool to rotate clockwise, simply push and turn the speed-regulating rod 22 rightward to let its blocking member 222 moved to the right side of the air intake hole 211. Thus, air will be guided by the right-handed guide recess 224 to pass through the right-handed through hole 214 and move toward the right-handed guide channel 15. When driven to rotate clockwise, the pneumatic tool will be rotated at different speeds because the area of the right-handed through hole 214 obstructed by the air-controlling surface 225 of the right-handed recess 224 are not the same. In addition, the sleeve 21 has the inner edge of its opposite sides respectively fitted with a O-shaped washer 216 to be engaged in the annular recess 221 for positioning the speed-regulating rod 22 and preventing leakage of air when the speed-regulating rod 22 is shifted in the sleeve 21.

However, the conventional right-handed and reverse air channel button 20 has to be provided with the 20 sleeve 21, the speed-regulating rod 22 and other members for changing the rotating direction and regulating the rotating speed of the pneumatic tool, thus increasing producing cost and complicating assembly. Moreover, to carry out change-over of rotation clockwise and counterclockwise of thee pneumatic tool, the speed-regulating rod 22 has to be turned and pressed to shift axially in the sleeve 21 with both hands, complicated and inconvenient in operation.

### SUMMARY OF THE INVENTION

The objective of this invention is to offer a right-handed and reverse air channel button for a pneumatic tool, which is composed of a basic body, at least one operating member and two air intake passageways. The basic body is pivotally positioned in a positioning hole of the base of a pneumatic tool; the operating member is firmly fixed at one axial side of the basic body and the two air intake passageways are grooves preset in shape and bored in the annular wall of the basic body. When the operating member is pulled and turned to actuate the basic body to rotate for a preset angle, the air intake passageways will respectively correspond to an air intake channel and two guide channels of the base, which communicate with the positioning hole, enabling air to get into the base through the right-handed and reverse air channel button for driving the pneumatic tool to rotate clockwise or counterclockwise. Further, the operating member secured at one axial side of the basic body can be operated with a single hand to turn the basic body to a proper angle relative to the positioning hole of the base, easy in assembly and convenient in operation. Furthermore, the open extent of the air intake passageways relative to the air intake channel can be regulated for controlling the amount of air getting into the base of the pneumatic tool through the right-hand and reverse air channel button, effectively controlling the amount of air.

### BRIEF DESCRIPTION OF DRAWINGS

This invention will be better understood by referring to the accompanying drawings, wherein:

FIG. 1 is an exploded perspective view of a right-handed and reverse air channel butt on of a conventional pneumatic tool;

FIG. 2 is a cross-sectional view of the base, and the right-handed and reverse air channel button of the conventional pneumatic tool;

FIG. 3 is a partial exploded perspective view of a right-handed and reverse air channel button for a pneumatic tool in the present invention;

FIG. 4 is an exploded perspective view of the right-handed and reverse air channel button in the present invention;

FIG. 5 is a cross-sectional view of the base of a pneumatic tool, and the right-handed and reverse air channel button in the present invention;

FIG. 6 is a side cross-sectional view of the right-handed and reverse air channel button in a non-operating condition in the present invention;

FIG. 7 is a first cross-sectional view of the right-handed and reverse air channel button in a non-operating condition in the present invention;

FIG. 8 is a second cross-sectional view of the right-handed and reverse air channel button in a non-operating condition in the present invention;

FIG. 9 is a side view of the right-handed and reverse air channel button in a right-handed operating condition in the present invention;

FIG. 10 is a first cross-sectional view of the right-handed and reverse air channel button in a right-handed operating condition in the present invention;

FIG. 11 is a second cross-sectional view of the right-handed and reverse air channel button in a. right-handed operating condition in the present invention;

FIG. 12 is a third cross-sectional view of the right-handed and reverse air channel button in a right-handed operating condition in the present invention;

FIG. 13 is a side view of the right-handed and reverse air channel button turned reversely in the present invention;

FIG. 14 is a first cross-sectional view of the right-handed and reverse air channel button turned reversely in the present invention;

FIG. 15 is a second cross-sectional view of the right-handed and reverse air channel button turned reversely in the present invention; and

FIG. 16 is a third cross-sectional view of the right-handed and reverse air channel button turned reversely in the present invention.

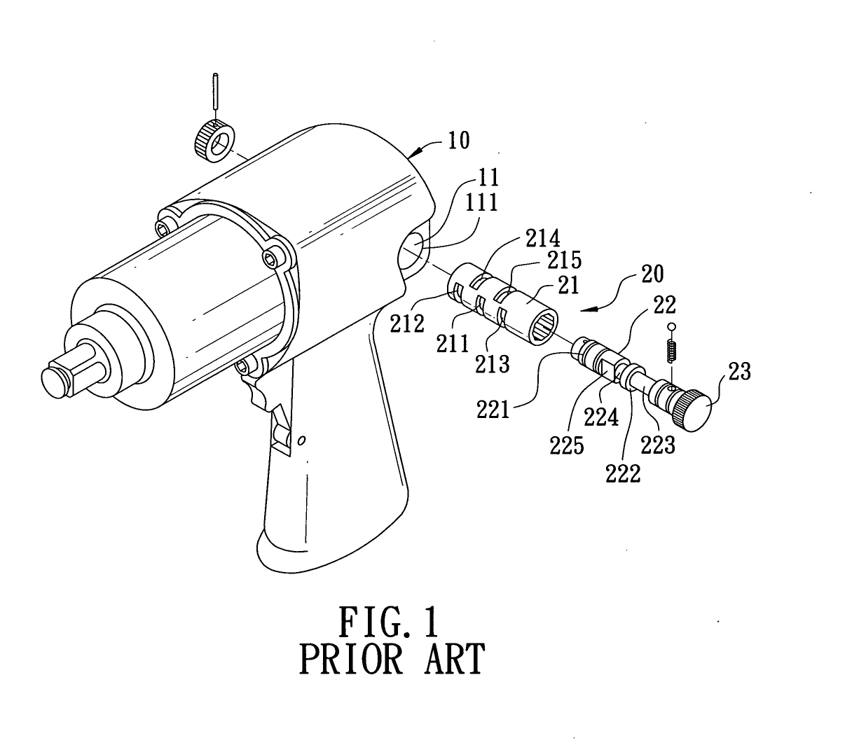

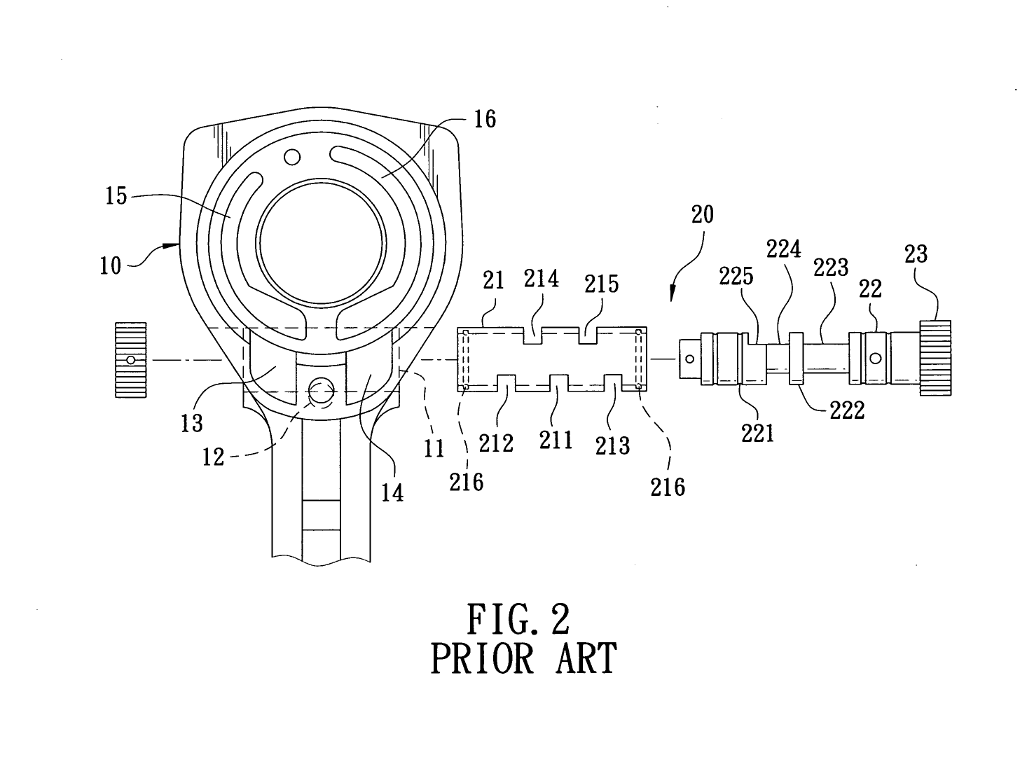

### DETAILED DESCRIPTION OF THE PREFERRED EMBODIMENT

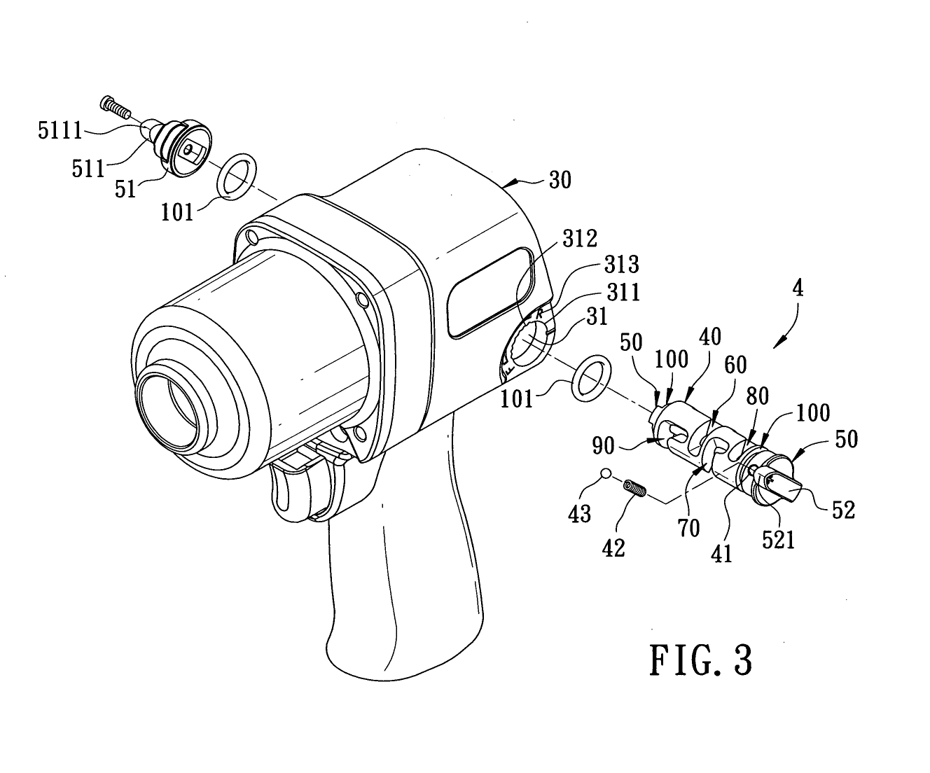

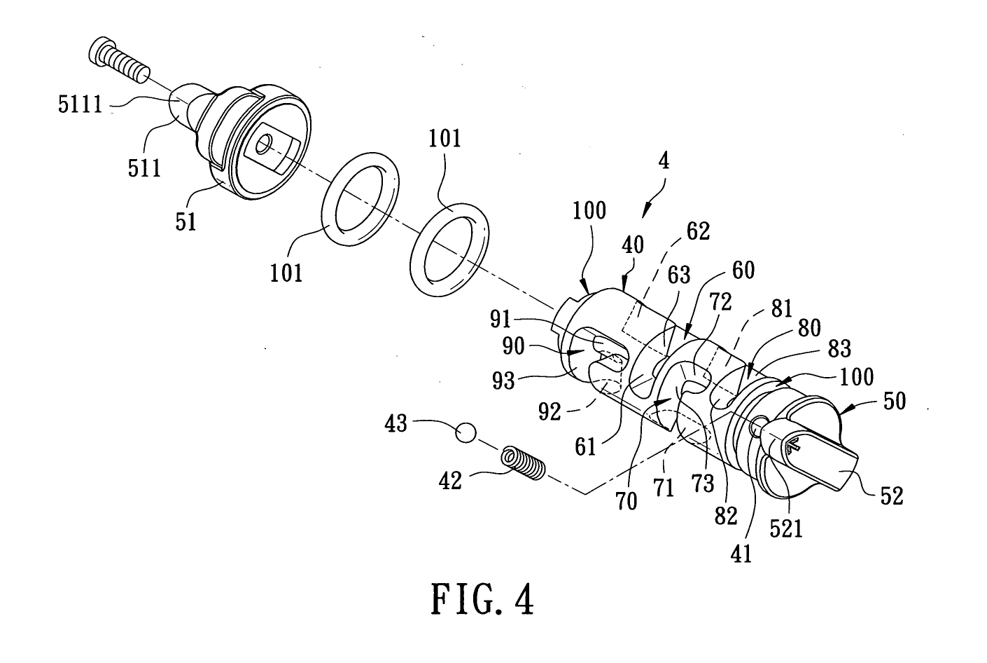

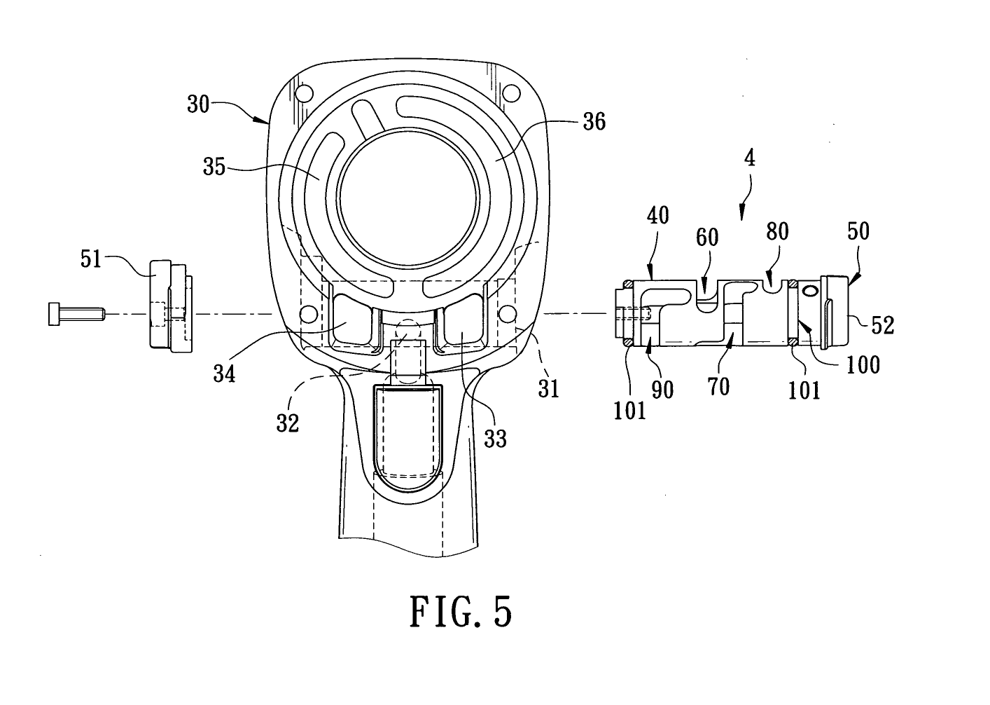

A preferred embodiment of a right-handed and reverse air channel button 4 is to be assembled in the base 30 of a pneumatic tool, as shown in FIGS. 3, 4 and 5. The base 30 of the pneumatic tool has its lateral side bored with a lengthwise positioning hole 31 having one opening 311 at a preset side annularly provided with position-limiting serrated member 312 and having the outer side of its two opposite openings 311 respectively provided with indicating marks 313 for facilitating a user to identify the operation directions of the pneumatic tool. The base 30 is formed integral in the interior with an air intake channel 32, a right-handed exhaust channel 33, a reverse exhaust channel 34, a right-handed guide channel 35 and a reverse guide channel 36 respectively communicating with the positioning hole 31.

The right-handed and reverse air channel button 4 is composed of a basic body 40, two operating members 50, a right-handed air intake passageway 70, a right-handed exhaust passageway 80, a reverse exhaust passageway 90 and two annular recesses 100.

The basic body 40 cylinder-shaped and tallying with the shape of the positioning hole 31 of the base 30 is pivotally inserted and positioned in the positioning hole 31 and able to be turned for a preset angle therein. The basic body 40 is further bored with a position-limiting hole 41 corresponding to the position-limiting serrated member 312 of the base 30 for receiving a spring 42 and a steel ball 43 therein.

The two operating members 50 are respectively secured at the axial opposite sides of the basic body 40. One of the two operating members 50, corresponding to the position-limiting serrated member 312, protrudes out of the positioning hole 31 of the base 30 for being conveniently turned to actuate the basic body 40 to rotate. The other operating member 50 is fitted thereon with an operating button 51 having its outer side fixed with a pull rod 511 having its upper side formed with a pointed cone-shaped pinpointing member 5111 for the operating button 51 to easily pulled to drive the basic body 40 to rotate. Further, the operating member 50 at the corresponding side of the position-limiting serrated member 312 of the base 30 is fixed with a long pull rod 52 formed with a pointed cone-shaped pinpointing member 521 at one side for matching with the indicating marks 313 of the base 30 so that a user can operate the pneumatic tool to rotate clockwise or counterclockwise in accordance with both the indicating member 521 of the operating member 50 and the indicating marks 313 of the base 30.

The right-handed air intake passageway 60 is an L-shaped groove bored in the annular wall of the basic body 40, having one end formed with a right-handed air intake inlet 61 corresponding to the air intake channel 32 of the base 30, and the other end formed with a right-handed air intake outlet 62 matching with the right-handed guide channel 35 of the base 30. The right-handed air intake inlet 61 and the right-handed air intake outlet 62 are connected by a right-handed air intake communicating member 63.

The reverse air intake passageway 70 is an L-shaped groove bored in the annular wall of the basic body 40 and reversely positioned at the outer side of the right-handed air intake passageway 60. The reverse air intake passageway 70 has one end formed with a reverse air intake inlet 71 corresponding to the air intake channel 32 of the base 30, and the other end formed with a reverse intake outlet 72 corresponding to the reverse guide channel 36 of the base 30. The reverse air intake inlet 71 and the reverse air intake outlet 72 are connected by a reverse air intake communicating member 73.

The right-handed exhaust passageway 80 is an L-shaped groove provided in the annular wall of the basic body 4 and positioned at the outer side of the reverse air intake passageway 70. The right-handed exhaust passageway 80 has one end provided with a right-handed exhaust inlet 81 matching with the reverse guide channel 36 of the base 30, and the other end disposed with a right-handed exhaust outlet 82 matching with the right-handed exhaust channel 33 of the base 30. The right-handed exhaust inlet 81 and the right-handed exhaust outlet 82 are connected by a right-handed exhaust communicating member 83.

The reverse exhaust passageway 90 is an L-shaped groove formed in the annular wall of the basic body 40, positioned at the other side of the right-handed air intake passageway 60, opposite to the reverse air intake passageway 70. The reverse exhaust passageway 90 has one end formed with a reverse exhaust inlet 91 corresponding to the right-handed guide channel 35 of the base 30 and the other end provided with a reverse exhaust outlet 92 matching with the reverse exhaust channel 34 of the base 30. The reverse exhaust inlet 91 and the reverse exhaust outlet 92 are connected by a reverse exhaust communicating member 93.

The two annular recesses 100 are respectively disposed at the axial opposite sides of the basic body 40 for two O-shaped washers 101 to be respectively fitted therein in order to prevent leakage of air.

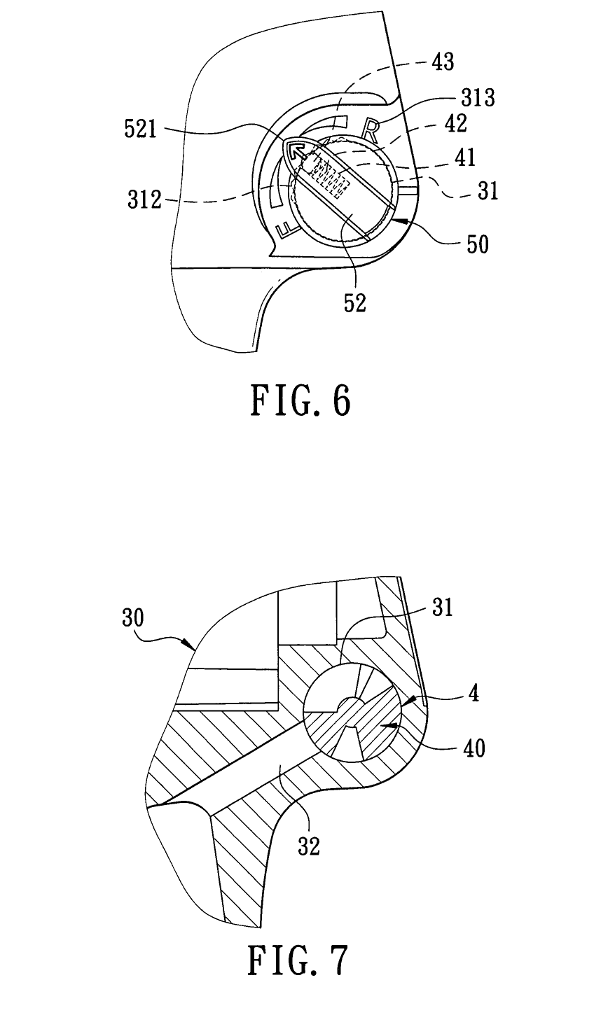

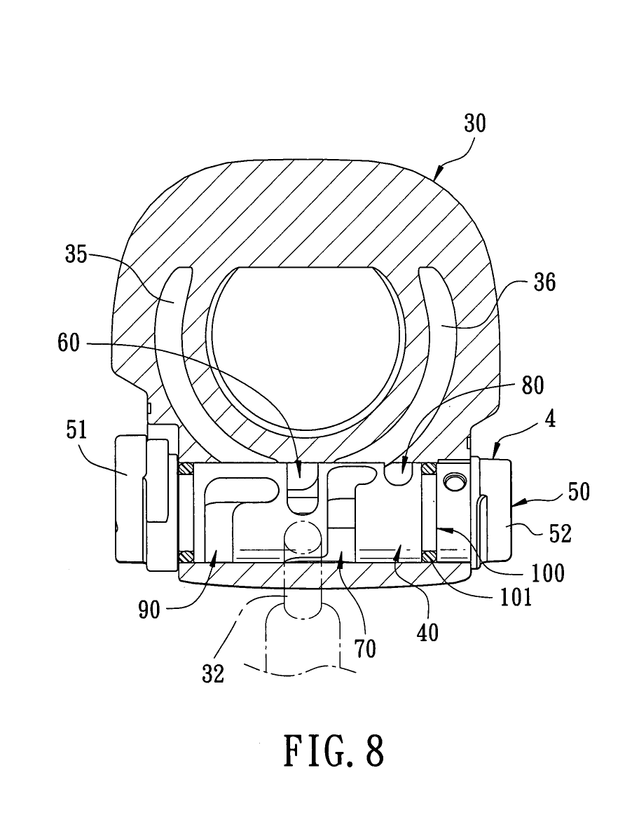

Referring to FIGS. 6, 7 and 8, when the operating member 50 of the right-handed and reverse air channel button 4 is turned to the intermediate portion of the positioning hole 31, the basic body 40 will completely seal up the opening of the air intake channel 32, which communicates with the positioning hole 31, and hence air cannot get into both the right-handed and reverse air channel button and the base 30 through the air intake channel 32. At this time, the right-handed band the reverse air intake passageway 60 and 70, and the right-handed and the reverse exhaust passageway 80 and 90 do not correspond to either the air intake channel 32 or the right-handed and the reverse guide channel 35 and 36, letting the pneumatic tool stop operating.

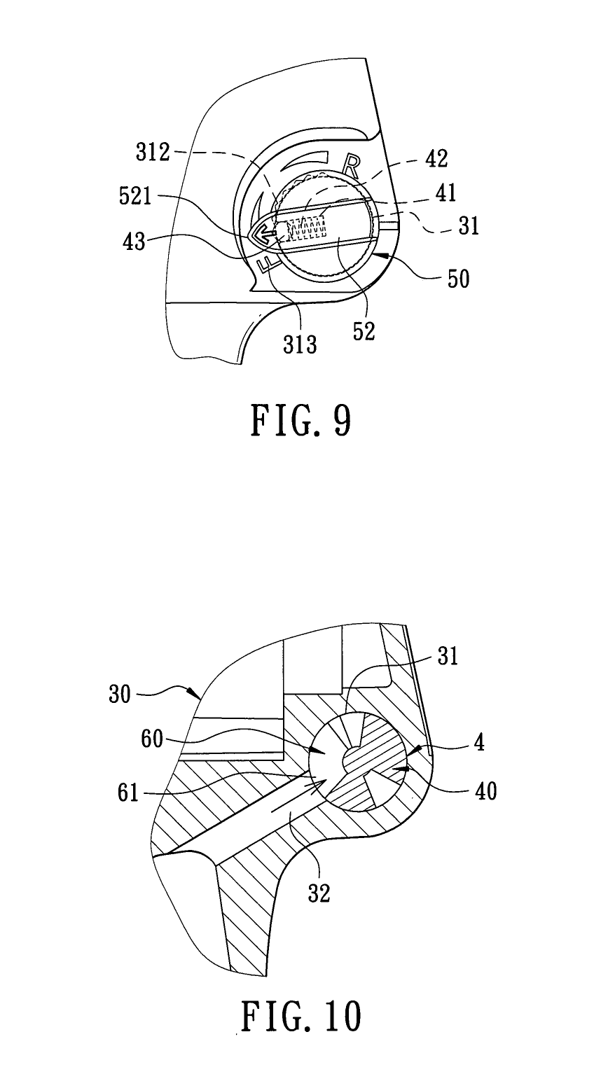

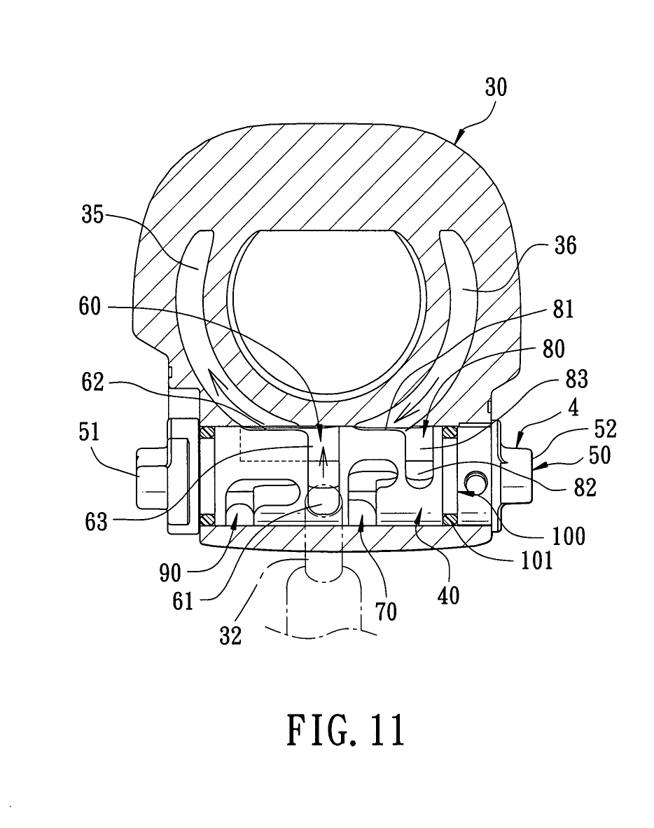

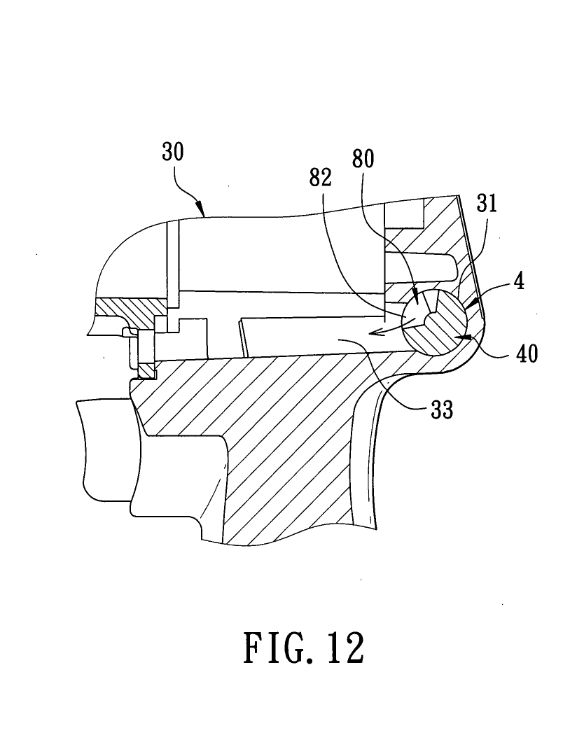

In operating, as shown in FIGS. 9 to 12, when the operating member 50 is turned forward, the right-handed air intake inlet 61 will communicate with the air intake channel 32 to enable air to pass through the air intake channel 32 and get into the right-handed air intake inlet 61 and the right-handed air intake communicating member 63 as well as the right-handed air intake outlet 62, and then get into the right-handed guide channel 35 that communicates with the right-handed air intake outlet 62 to drive the pneumatic tool to rotate clockwise. At this time, the right-handed exhaust-intake member 81 communicates with the reverse guide channel 36 to enable the air to pass through the reverse guide channel 36 and get into the right-handed exhaust inlet 81, and simultaneously the air will pass through the right-handed exhaust communicating member 83 and the right-handed exhaust outlet 82 and get to the right-handed exhaust channel 33 that communicates with the right-handed exhaust outlet 82 to be exhausted out. Further, the two annular washers 101 respectively fitted in the two annular recesses 100 are able to prevent the flowing air from leaking out so that air can be precisely sent in or exhausted out of the base 30 of the pneumatic tool through the right-handed and reverse air channel button 4. Furthermore, when the operating member 50 is pulled and turned, the steel ball 43 in the position-limiting hole 41 will be pushed by the spring 42 to be fixedly engaged with the position-limiting serrated member 312 of the base 30 to firmly fix the operating member 50 in position. At this time, a user can turn the operating button 51 of the basic body 40 with a single hand to actuate the corresponding operating member 50 and the basic body 40 to rotate, convenient in operation.

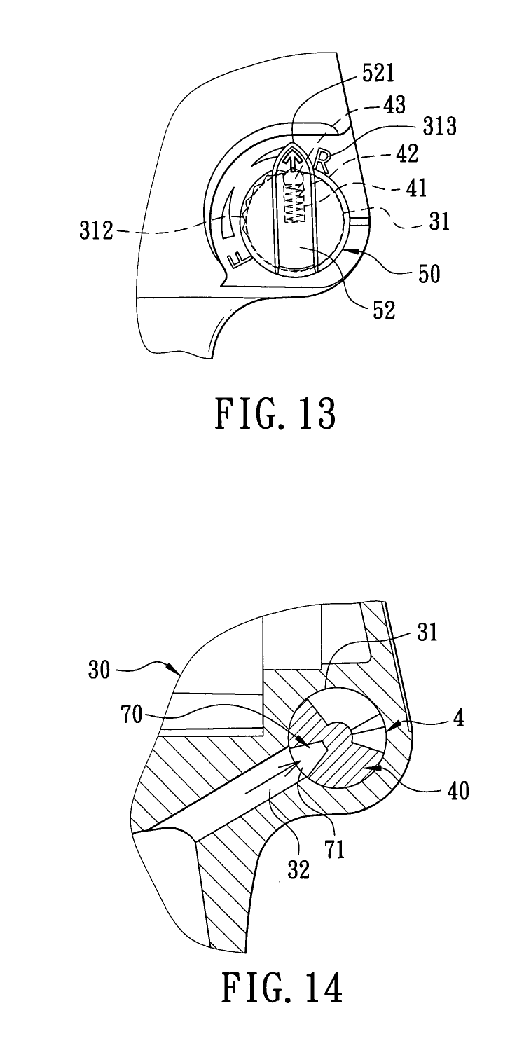

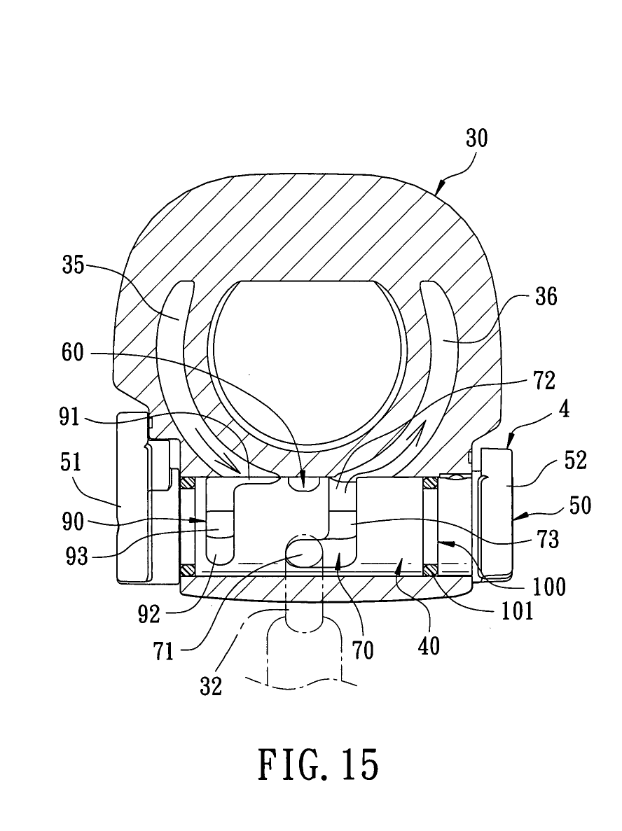

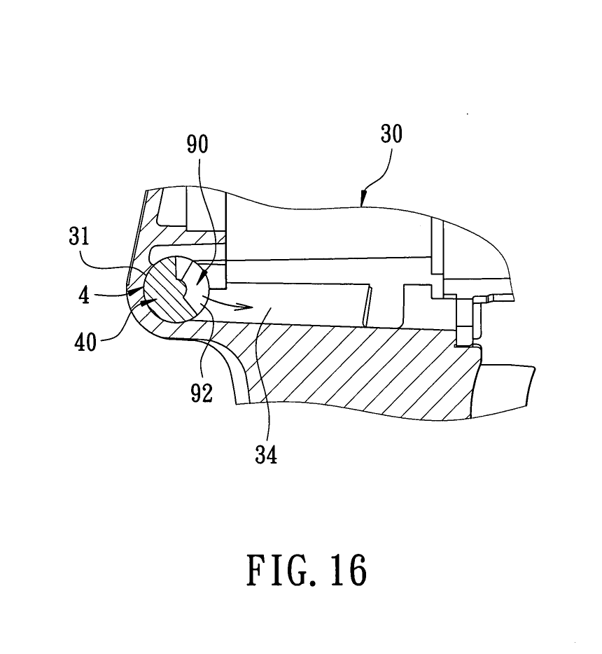

Referring to. FIGS. 13 to 16, when the operating member 50 or the operating button 51 is turned backward, the basic body 40 relative to the positioning hole 31 will be rotated backward for a preset angle to let the reverse air intake inlet 71 communicate with the air intake channel 32 of the base 30. Thus, air can pass through the air intake channel 32 and get into the reverse air intake inlet 71 and the reverse air intake communicating member 73 as well as the reverse intake outlet 72 and then get into the reverse guide channel 36 that communicates with the reverse intake outlet 72 to drive the pneumatic tool to rotate counterclockwise. At this time, the reverse exhaust inlet 91 communicates with the right-handed guiding channel 35; therefore, air can pass through the right-handed guide channel 35 and get to the reverse exhaust inlet 91, and simultaneously the air will pass through the reverse exhaust communicating member 93 and the reverse exhaust outlet 92 and get to the reverse exhaust channel 34 that communicates with the reverse exhaust outlet 92 to be exhausted out.

Thus, by turning the operating member 50 or the operating button 51 for an angle, the right-handed and reverse air channel button 4 can control the opening extent of the air intake passageways 60, 70 and the exhaust passageways 80, 90 relative to the air intake channel 32 and the exhaust channels 33, 34 for regulating the amount of air. For instance, when the operating member 50 or the operating button 51 is turned forward or backward to opposite sides, the air intake passageways 60, 70 or the exhaust passageway 80, 90 will completely communicate with the air intake channel 32 and the exhaust channels 33, 34, and hence air getting into the base 30 will reach a maximum amount and the pneumatic tool will be rotated at the highest speed.

As can be understood from the above description, this invention has the following advantages.

1. The right-handed and reverse air channel button of this invention has its basic body formed integral with the right-handed and the reverse air intake passageways, simple in structure, easy to control the pneumatic tool to rotate clockwise or counterclockwise and also regulate its rotating speeds, able to lower processing and assembling cost. In addition, the right-handed and reverse air channel button is provided with indicating marks R (rearward) and F (frontward). Thus, when the pull rod is turned to the mark F, the pneumatic tool will be rotated clockwise, while turned to the mark R, the pneumatic tool will be rotated counterclockwise, convenient in operation and use.

2. By turning the operating member or the operating button with a single hand, the basic body of the right-handed and reverse air channel button can be rotated to control the open extent of the air intake passageway and the exhaust passageway relative to the air intake and the exhaust channel of the base of the pneumatic tool for regulating the amount of air.

3. The basic body of the right-handed and reverse air channel button is rotated forward and backward; therefore, the two O-shaped washers can be prevented from being damaged, able to prolong service life of the washers and prevent leakage of air.

While the preferred embodiment of the invention has been described above, it will be recognized and understood that various modifications may be made therein and the appended claims are intended to cover all such modifications that may fall within the spirit and scope of the invention.

I claim

1. A right-handed and reverse air channel button pivotally fitted in a lengthwise positioning hole of the base of a pneumatic tool, said positioning hole having its opposite sides respectively formed with an opening, said base of said pneumatic tool bored in the interior with an air intake channel, two exhaust channels and two guide channels respectively communicating with said positioning hole;
said right-handed and reverse air channel button provided with a cylindrical basic body, said basic body pivotally positioned in said positioning hole of said base, said basic body able to be rotated for a preset angle in said positioning hole, said basic body at least having one axial side provided with an operating member, said operating member protruding out of said positioning hole for easily turned to actuate said basic body to rotate, said basic body having its annular wall formed with at least two air intake passageways spaced apart, said two air intake passageways being two grooves located reversely, said two air intake passageways respectively having one end provided with an air intake member communicating with said air intake channel of said base, said two air intake passageways respectively having the other end formed with an exhaust member communicating with said two guide channels of said base, said air intake member and said exhaust member of each said air intake passageway connected by a communicating member; and
the relative contact locations between said two air intake passageways and said air intake channel able to be controlled to let said air intake channel communicate with one of said two air intake passageways for driving said pneumatic tool to rotate clockwise or counterclockwise, an area of relative contact location between said air intake passageway and said air intake channel able to be regulated for controlling the amount of air getting into said air intake passageway so as to regulate the rotating speed of said pneumatic tool.

2. The right-handed and reverse air channel button as claimed in claim 1, wherein two exhaust passageways are respectively provided at the opposite outer sides of said two air intake passageways, bored in the annular wall of said basic body and positioned reversely to each other, said two exhaust passageways respectively having one end formed with an air intake member communicating with said two guide channels of said base, said two exhaust passageways respectively having the other end provided with an exhaust member communicating with said two exhaust channels of said base, said air intake member and said exhaust member of each said exhaust passageway connected by a communicating member.

3. The right-handed and reverse air channel button as claimed in claim 1, wherein said basic body of said right-handed and reverse air channel button has its axial opposite sides respectively provided with an annular recess for receiving two rings therein.

4. The right-handed and reverse air channel button as claimed in claim 3, wherein said rings are O-shaped washers.

5. The right-handed and reverse air channel button as claimed in claim 1, wherein said opening of said positioning hole of said base at the corresponding side of said operating member is annularly disposed with a position-limiting serrated member, and said basic body is bored with a position-limiting hole matching with said position-limiting serrated member for receiving a spring and a steel ball therein, said steel ball elastically pushed by said spring to be restrictedly fitted in said position-limiting serrated member.

6. The right-handed and reverse air channel button as claimed in claim 1, wherein said positioning hole at the corresponding side of said operating member has the outer wall of said opening provided with indicating marks.

7. The right-handed and reverse air channel button as claimed in claim 6, wherein said operating member is secured with a long pull rod having the corresponding side of said indicating mark formed with a pointed con-shaped pinpointing member.

8. The right-handed and reverse air channel button as claimed in claim 1, wherein said basic body has the other axial side, opposite to said operating member, provided with a second operating member, said second operating member fixed thereon with an operating button to be turned for actuating said basic body to rotate.

9. The right-handed and reverse air channel button as claimed in claim 8, wherein said operating button is fixed thereon with a long pull rod having its upper side formed with a pointed cone-shaped pinpointing member. I 0 1 5 20 25
